(19) United States
(12) Patent Application Publication
(10) Pub. No.: US 2012/0100434 A1
(43) Pub. Date: Apr. 26, 2012

(54) LIQUID ELECTROLYTE FOR LITHIUM ACCUMULATOR, COMPRISING A MIXTURE OF NON-AQUEOUS ORGANIC SOLVENTS

(75) Inventors: Severine Jouanneau-Si Larbi, Sillans (FR); Lise Daniel, Saint Marcellin (FR); Florence Masse, Grenoble (FR)

(73) Assignee: COMMISSARIAT A L'ENERGIE ATOMIQUE ET AUX ENERGIES ALTERNATIVES, PARIS (FR)

(21) Appl. No.: 13/381,513

(22) PCT Filed: Jul. 1, 2010
(86) PCT No.: PCT/FR10/00484

§ 371 Date: Dec. 29, 2011

(30) Foreign Application Priority Data
Jul. 16, 2009 (FR) 0903490

(51) Int. Cl. H01M 10/056

(52) U.S. Cl. 429/331; 429/334

(57) ABSTRACT

The invention related to a liquid electrolyte for a lithium battery comprising a lithium salt dissolved in a mixture of three non-aqueous organic solvents. This mixture consists of:

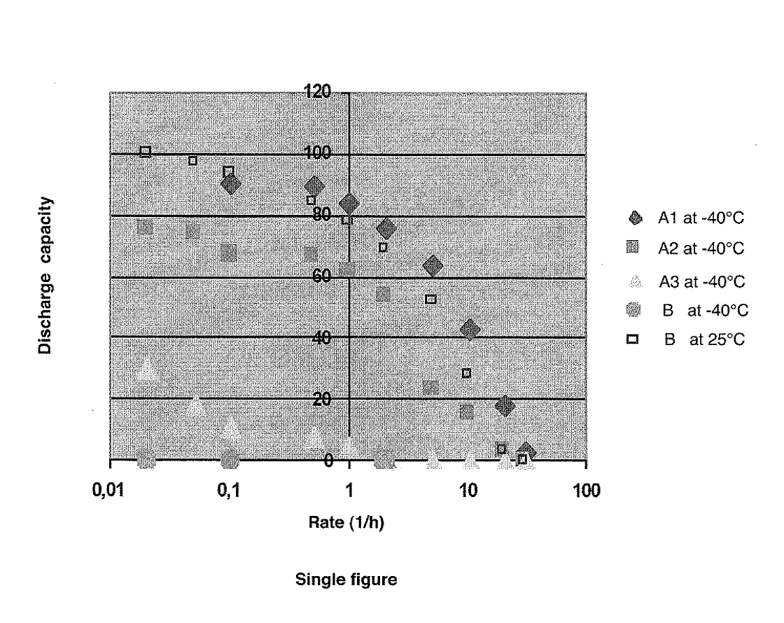

33% to 49 volume % of propylene carbonate,

33% to 49 volume % of diethyl carbonate, and

2% to 34 volume % of ethyl acetate.

The liquid electrolyte is in particular suitable for a lithium battery based on the LiFePO₄/Li₄Ti₅O-₁₂ pair or derivatives thereof, these materials being the respective active materials of the positive and negative electrodes. Such a lithium battery in fact has the advantage of operating in power, over a wide temperature range, while at the same time preserving a low self-discharge capacity.

### BACKGROUND OF THE INVENTION

The invention relates to a liquid electrolyte for a lithium storage battery comprising at least a lithium salt dissolved in a mixture of three non-aqueous organic solvents.

### STATE OF THE ART

Lithium storage batteries are tending to replace nickel-cadmium (Ni—Cd) or nickel-metal hydride (Ni—MH) storage batteries as autonomous energy source, in particular in portable equipment. The performances and more particularly the specific and volume energy densities of lithium batteries such as lithium-ion (Li-Ion) batteries are in fact higher than those of Ni—Cd and Ni—MH batteries.

These lithium storage batteries operate on the principle of insertion or extraction (or intercalation/deintercalation) of lithium in at least the active material of the positive electrode. In general, the active material of the positive electrode is a lithium oxide and at least a transition metal such as LiCoO₂, LiNiO₂ and LiMn₂O₄. More recently, it has been proposed to use the LiFePO₄ compound as active material for the positive electrode.

The active material of the negative electrode can further be either metal lithium or a lithium-based alloy (Li-Metal storage battery) or, as for the active material of the positive electrode, a material able to insert and extract Li⁺ ions (Li-Ion storage battery).

For a Li-Ion storage battery, the active material of the negative electrode is in general based on a carbon material such as graphite.

Other materials can also be envisaged to form the active material of the negative electrode.

For example purposes and as mentioned in the International application WO-A-2006/027449, a mixed titanium and lithium oxide of Li₄Ti₅O₁₂ type can also be used as active material of a negative electrode of a Li-Ion battery.

Finally, the electrolyte can be a liquid electrolyte impregnating a separator arranged between the positive and negative electrodes. In this case, the liquid electrolyte generally comprises lithium salt dissolved in one or more non-aqueous organic solvents, in particular of the carbonate family.

The type of electrolyte used is an important factor in the performance of lithium storage batteries, in particular when the latter are used at very low or very high temperatures.

For example purposes, Patent U.S. Pat. No. 6,541,162 describes an electrolyte for a lithium storage battery comprising a lithium salt dissolved in a mixture of three non-aqueous organic solvents. The mixture more particularly comprises:
between 20 and 70 volume % of a cyclic carbonate such as ethylene carbonate (known under the Anglo-Saxon acronym EC) and propylene carbonate (known under the Anglo-Saxon acronym PC),
between 20 and 70 volume % of a chain carbonate such as dimethyl carbonate (known under the Anglo-Saxon acronym DMC), diethyl carbonate (known under the Anglo-Saxon acronym DEC), ethyl methyl carbonate and methyl propyl carbonate,
and between 40 and 60 volume % of an alkyl acetate such as n-methyl acetate (known under the Anglo-Saxon acronym MA), n-ethyl acetate (known under the Anglo-Saxon acronym EA) and n-propyl acetate (known under the Anglo-Saxon acronym PA).

Patent U.S. Pat. No. 6,541,162 more particularly tested the performances, in particular the capacity in discharge, at a rate of 0.2 C and at −20° C., of a lithium battery comprising LiCoO₂ or a derivative thereof as active material of the positive electrode, a carbon-based compound for the active material of the negative electrode and with the following mixtures of solvents: EC/DEC/PA (3:3:4), EC/EMC/PA (3:3:4), EC/DMC/PA (3:3:4), EC/DMC/MA (3:3:4) and EC/DMC/EA (3:3:4).

In the patent application EPO482287, a lithium battery comprises a complex oxide with lithium as the active material of the positive electrode, a carbon-based material for the negative electrode and a non-aqueous electrolyte formed by an inorganic salt dissolved in a mixture comprising a cyclic ester and an additional solvent, with a volume ratio between the additional solvent and the cyclic ester of 1 for 4. The cyclic ester is at least a cyclic ester selected from the group consisted of ethylene carbonate, propylene carbonate, butylene carbonate and gamma-butyrolactone and the additional solvent is at least a solvent chosen from diethyl carbonate, dimethyl carbonate, methyl carbonate, ethyl formate, ethyl acetate, methyl acetate and dimethyl sulfoxide. The lithium batteries tested in the patent application EPO482287 all contain a liquid electrolyte formed with a mixture of EC/DEC solvents.

Object of the Invention

The object of the invention is to propose a new liquid electrolyte for a lithium battery, and more particularly which is suitable for a lithium battery comprising LiFePO₄ and a titanium oxide which may be lithiated (for example Li₄Ti₅O₁₂) or a derivative thereof to form the respective active materials of the positive electrode and the negative electrode.

According to the invention, this object is achieved by a liquid electrolyte for a lithium battery comprising at least a lithium salt dissolved in a mixture of three non-aqueous organic solvents, characterized in that the mixture consists of
33% to 49 volume % of propylene carbonate,
33% to 49 volume % of diethyl carbonate,
and 2% to 34 volume % of ethyl acetate.

It is a further object of the invention to propose a lithium battery comprising the active material pair formed by LiFePO₄ (or a derivative thereof) and titanium oxide that is possibly lithiated (or a derivative thereof) for the positive electrode and the negative electrode, operating in power over a wide temperature range while at the same time preserving a low self-discharge capacity comparable with that obtained with standard electrolytes.

This object is also achieved by a lithium battery comprising
a positive electrode comprising LiFePO₄ or a derivative thereof as positive active material,
a negative electrode comprising a titanium oxide or a derivative thereof as negative active material,
and a separator arranged between the positive and negative electrodes and imbibed with a liquid electrolyte such as the one mentioned above.

### BRIEF DESCRIPTION OF THE DRAWINGS

Other advantages and features will become more clearly apparent from the following description of particular embodiments of the invention, given for non-restrictive example purposes only and represented in the appended drawings in which:

The appended single FIGURE represents the variation of the discharge capacity versus the rate of batteries A1, A2, A3 and B at −40° C. and of battery B at 25° C.

### DESCRIPTION OF PARTICULAR EMBODIMENTS

Three specific non-aqueous organic solvents, and also their respective volume proportions, were chosen to form the solvent mixture of a liquid electrolyte for a lithium battery.

In particular, the solvents selected to form the mixture are:
propylene carbonate, also known under the Anglo-Saxon acronym PC,
diethyl carbonate, also known under the Anglo-Saxon acronym DEC
ethyl acetate, also known under the Anglo-Saxon acronym EA.

Furthermore, the respective volume proportions of these three solvents in the mixture are the following:
between 33% and 49 volume % for PC,
between 33% and 49 volume % for DEC
and between 2% and 34 volume % for EA.

The sum of the respective volume proportions of EA, PC and DEC enable 100% to be reached. The mixture therefore does not contain any other solvent(s) than the three solvents PC, DEC and EA. More particularly, it does not contain ethylene carbonate (EC) as in the examples of solvent mixtures disclosed according to the prior art.

Furthermore, the volume proportion of EA in the solvent mixture is advantageously comprised between about 5% and about 33% and even more advantageously between about 10% and about 33%.

Such a solvent mixture is more particularly used to dissolve at least a lithium salt, for example chosen from LiClO₄, LiAsF₆, LiPF₆, LiBF₄, LiR_{F}SO₃, LiCH₃SO₃, LiN(R_{F}SO₂)₂ and LiC(R_{F}SO₂)₃. R_{F} is in particular a perfluoro-alkyl group comprising between 1 and 8 carbon atoms or a fluoride atom.

The solvent mixture formed by 33% to 49 volume % of PC, 33% to 49 volume % of DEC and 2% to 34 volume % of EA and comprising at least the dissolved lithium salt then forms a liquid electrolyte that is particularly suitable for a lithium battery comprising the LiFePO₄/Li₄Ti₅O₁₂ active material pair.

It has in fact been found that such an electrolyte associated with the pair of active materials LiFePO₄/Li₄Ti₅O₁₂ enables a lithium battery to be produced delivering a high power at high current rates, while at the same time having a low self-discharge over a wide temperature range, in particular for extremely low and extremely high temperatures. What is meant by self-discharge is the ability of a battery placed in the charged state to discharge, even when it is not used or is “on the shelf”.

For illustration purposes, three series of Li-Ion batteries, respectively called A1, A2, A3 and only differing by the PC: DEC: EA solvent mixture used to form the liquid electrolyte (mixtures respectively noted al, a2 and a3), are produced.

Mixtures a1, a2 and a3 are all constituted by PC, DEC and EA, but in different volume proportions, as indicated in table 1 below:

TABLE 1

| | a1 | a2 | a3 |
|---|---|---|---|
| PC:DEC:EA | 1:1:1 | 3:3:1 | 7:7:1 |

The series of batteries A1, A2 and A3 each comprise LiFePO₄/Li₄Ti₅O₁₂ as pair of active materials for respectively the positive and negative electrodes.

In particular, each electrode is formed by depositing the following mixture on an aluminium current collector:
80 weight % of active material (LiFePO₄ for the positive electrode and Li₄Ti₅O₁₂ for the negative electrode),
de 8 weight % of carbon black used as conducting material,
and 12 weight % of polyvinylidene hexafluoride as binder.

With electrodes having a surface of about 6 cm² and a surface capacity of about 1 mAh/cm², lithium batteries can advantageously deliver a capacity of about 6 mAh/cm².

Furthermore, 1 M of LiPF₆ is used as lithium salt dissolved in mixtures a1, a2 and a3 to form the liquid electrolyte. The latter imbibes a separator arranged between the positive and negative electrodes. The separator is more particularly a separator of Celgard® type.

For comparison purposes, a fourth series of Li-Ion batteries, called B, is also produced. Compared with the series A1, A2 and A3, series B only differs by the solvent mixture used (mixture b). Mixture b is formed by ethylene carbonate (EC) and diethyl carbonate (DEC) in 1:1 volume proportions.

A first test is carried out with these 4 series of lithium batteries in order to evaluate their self-discharge.

This test first consists in charging the lithium batteries by performing a few cycles at a relatively slow rate. Then the batteries charged in this way are stored at 40° C. in order to place them in accelerated ageing conditions. The capacity delivered on discharge for each battery A1, A2, A3 and B is then checked after 14 days of storage at 40° C., which enables the self-discharge of the lithium battery to be evaluated. Table 2 below more particularly shows the self-discharge measuring protocol performed during this first test.

TABLE 2

| Step | Temperature | Rate | Observations |
|---|---|---|---|
| 1 | 25° C. | C/5 | 1 charge to 2.6 V and 1 discharge to 1 V |
| 2 | 25° C. | C/5 | 1 charge up to 2.6 V |
| 3 | 40° C. | 0 | Open-Circuit Voltage (OCV) monitoring |
| 4 | 25° C. | C/5 | 1 discharge up to 1 V in order to evaluate self- |
| | | | discharge then return to step 3 |

The storage delivered capacities of each storage battery A1, A2 A3 and B are set out in table 3 below. These delivered capacities correspond to the percentage of capacity of a storage battery after 14 days of storage at −40° C. compared with the initial capacity of said storage battery at 25° C., at C/10 rate.

TABLE 3

| | A1 | A2 | A3 | B |
|---|---|---|---|---|
| Storage delivered | 92 | 91 | 90.5 | 91 |
| capacity | | | | |

As indicated in table 3, self-discharge for batteries A1, A2 and A3 is comparable to that of battery B. In all cases, it remains low.

A second test is performed with the 4 series of lithium batteries A1, A2, A3 and B to evaluate their behaviour when they are subjected to multiple discharge at successive power rates.

Table 4 below indicates the different power rates applied to the batteries.

TABLE 4

| Step | T° | Rate | Observations |
|---|---|---|---|
| 1 | 25° C. | C/5 | 1 reference cycle |
| | | | (charge to 2.6 V + discharge to 1 V)) |
| 2 | 25° C. | C/5 | 1 charge up to 2.6 V |
| 3 | −40° C. | Successive currents | 1 multiple discharge up to 1 V |
| | | of 30 C. up to C/50, | |
| | | interrupted with | |
| | | relaxation intervals | |
| | | of 1/2 h | |

Thus, as represented in the appended figure, it can be observed that battery B, which presents an interesting behaviour at 25° C., loses its residual capacity (% of the capacity with respect to the initial capacity at 25° C.) at −40° C. The behaviour in face of multiple discharging of lithium batteries Al to A3, at −40° C., is on the other hand improved compared with that of battery B at −40° C. The behaviour of batteries A1 and A2 at −40° C. is moreover substantially comparable to that of lithium battery B at 25° C.

A third test is performed with the series of lithium batteries A1 and B in order to evaluate their behaviour when they are subjected to current pulses of variable times and for different exterior temperatures.

This third test is therefore carried out with a pulsed current Cₚ of 10 C, with two pulse times (Tₚ) respectively of 300 ms (Pulse n° 1) and 1000 ms (Pulse n° 2) and for different exterior temperatures.

The results are set out in table 5 below. The “/” sign means that the test was not performed in this specific case whereas the “+” and “−” signs respectively correspond to a response of the battery to the given current pulse being obtained or not.

TABLE 5

| T° | Battery | Pulse | Response |
|---|---|---|---|
| 90° C. | B | N°1 | / |
| | | N°2 | / |
| | A1 | N°1 | + |
| | | N°2 | + |
| 80° C. | B | N°1 | + |
| | | N°2 | + |
| | A1 | N°1 | + |
| | | N°2 | + |
| 55° C. | B | N°1 | + |
| | | N°2 | + |
| | A1 | N°1 | / |
| | | N°2 | /1 |
| 25° C. | B | N°1 | + |
| | | N°2 | + |
| | A1 | N°1 | + |
| | | N°2 | + |
| −20° C. | B | N°1 | + |
| | | N°2 | + |
| | A1 | N°1 | / |
| | | N°2 | / |
| −30° C. | B | N°1 | − |
| | | N°2 | − |
| | A1 | N°1 | + |
| | | N°2 | + |
| −40° C. | B | N°1 | / |
| | | N°2 | / |
| | A1 | N°1 | + |
| | | N°2 | + |

The results set out in table 5 therefore show that battery A1 enables a response to be obtained for both the current pulse times whatever the exterior temperature. This is not the case of battery B as there is no response at −30° C.

Finally, the lithium battery according to the invention is not limited to the particular embodiments described in the foregoing. More particularly, the liquid electrolyte comprising the mixture of 3 solvents PC/DEC/EA can be associated with the active materials for the positive and negative electrodes formed by derivatives of LiFePO₄ and of Li₄Ti₅O₁₂. LiFePO₄ can thus for example be replaced by a derivative thereof, such as LiFeMPO₄, with M chosen from at least Co, Ni and Mn. Likewise, Li₄Ti₅O₁₂ can be replaced by another lithiated titanium oxide or by a derivative thereof, such as a Li₄Ti₅O₁₂ compound in which the titanium is partially substituted by a transition element or by an alkaline earth. Finally, the titanium oxide forming the negative active material can also be a non-lithiated titanium oxide such as TiO₂.

1-9. (canceled)

10. A liquid electrolyte for a lithium battery comprising at least one lithium salt dissolved in a mixture of three non-aqueous organic solvents, wherein the mixture is constituted by:
33% to 49 volume % of propylene carbonate,
33% to 49 volume % of diethyl carbonate,
and 2% to 34 volume % of ethyl acetate.

11. The electrolyte according to claim 10, wherein the mixture contains between about 10% and about 33 volume % of ethyl acetate.

12. The electrolyte according to claim 10, wherein the mixture presents a volume ratio of 1:1:1, respectively for the propylene carbonate, the diethyl carbonate and the ethyl acetate.

13. The electrolyte according to claim 10, wherein the mixture presents a volume ratio of 3:3:1, respectively for the propylene carbonate, the diethyl carbonate and the ethyl acetate.

14. The electrolyte according to claim 10, wherein the mixture presents a volume ratio of 7:7:1, respectively for the propylene carbonate, the diethyl carbonate and the ethyl acetate.

15. The electrolyte according to claim 10, wherein the lithium salt is selected from the group consisting of LiClO₄, LiAsF₆, LiPF₆, LiBF₄, LiR_{F}SO₃, LiCH₃SO₃, LiN(R_{F}SO₂)₂ and LiC(R_{F}SO₂)₃, R_{F} being a fluorine atom or a perfluoro-alkyl group comprising between 1 and 8 carbon atoms.

16. A lithium battery comprising:
a positive electrode comprising LiFePO₄ or a derivative thereof as positive active material,
a negative electrode comprising a titanium oxide or a derivative thereof as negative active material,
and a separator arranged between the positive and negative electrodes and imbibed with a liquid electrolyte according to claim 1.

17. The lithium battery according to claim 16, wherein the titanium oxide is a lithiated titanium oxide.

18. The lithium battery according to claim 17, wherein the titanium oxide is Li₄Ti₅O₁₂.
